(19) United States
(12) Patent Application Publication
(10) Pub. No.: US 2009/0195870 A1
(43) Pub. Date: Aug. 6, 2009

(54) SAMPLE STAGE FOR OPTICAL INSPECTION

(75) Inventor: Kenji Norimatsu, Oita-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/354,196

(22) Filed: Jan. 15, 2009

(30) Foreign Application Priority Data
Jan. 15, 2008 (JP) 2008-005689

(51) Int. Cl. G02B 21/26

(52) U.S. Cl. 359/391

(57) ABSTRACT

A sample stage is provided with first to fourth plates. Each of the first to fourth plates has a first side surface and a second side surface. The first and the second side surfaces are adjacent to each other. The first and the second side surfaces extend perpendicularly to each other. The second side surface of the second plate is in contact with the first side surface of the first plate. The second side surface of the third plate is in contact with the first side surface of the second plate. The second side surface of the fourth plate is in contact with the first side surface of the third plate. The second side surface of the first plate is in contact with the first side surface of the fourth plate. A first rectangular opening is formed by the first side surfaces of the first to fourth plates.

### CROSS REFERENCE TO RELATED APPLICATION

This application is based upon and claims the benefit of priority from the prior Japanese Patent Application No. 2008-5689, filed on Jan. 15, 2008, the entire contents of which are incorporated herein by reference.

### FIELD OF THE INVENTION

The invention relates to a sample stage for use in optical inspection of a sample such as a semiconductor chip.

### DESCRIPTION OF THE BACKGROUND

Various tests are performed on a semiconductor device during manufacturing of the semiconductor device or after the completion of the manufacturing. A failure analysis is performed on a semiconductor device when it is determined to be faulty. The failure analysis contributes to improvement in production yield and quality of semiconductor devices.

Japanese Patent Application Publication No. 7-14898 discloses an equipment for performing a wafer level test of semiconductors and for performing failure analysis.

The test and analysis equipment is provided with a wafer chuck and a probe card which has metal needles and is movable along X, Y and Z axes. A semiconductor wafer is attached to the wafer chuck. The metal needles of the probe card are brought into contact with electrode pads formed on a surface of a semiconductor wafer, in order to supply pulse test signals to the electrode pads through the metal needles.

A current generated in the semiconductor wafer is detected at the electrode pads. An optical microscope radiates light onto the semiconductor wafer, detects reflection light of the radiated light, and performs optical analysis of the detected light. The radiation of the light and the detection of the reflected light are performed on the back side of the semiconductor wafer. Analysis of a faulty portion of the semiconductor wafer is performed by OBIC analysis, OBIRCH analysis, LVP analysis, TRE analysis, or PEM analysis while the semiconductor wafer is in actual operation.

The test and analysis equipment is an apparatus for performing the test and analysis on the basis of a wafer level. Therefore, a semiconductor chip, which is taken out of a package, can not be attached to the wafer chuck to perform the failure analysis.

Japanese Patent Application Publication No. 2003-209862 discloses an inspection equipment to inspect semiconductor chips mounted on a wafer-shaped transparent base plate.

In the inspection equipment, a plurality of image sensors, which are semiconductor chips, are arrayed on a surface of the transparent base plate. The electrical characteristics of the arrayed image sensors are inspected. The inspection equipment is provided with a holder to hold the transparent base plate. The inspection equipment is also provided with a turn-over mechanism to turn over the holder so as to make a back surface of the transparent base plate face upward. The back surface of the transparent base plate, which is turned over by the turn-over mechanism, is irradiated with light from a light source. Inspection of the electrical characteristics is performed while the back surface is irradiated with light from the light source.

In the inspection equipment, an optical component is used to detect the reflected light of the irradiation light. The transparent base plate does not allow the optical component to be close to or firmly attached to the back surface of the image sensors. As a result, the optical image of the reflected light cannot be observed at high resolution.

Furthermore, when the transparent base plate is made of glass, heat is not sufficiently diffused from the semiconductor chip. The insufficient heat diffusion occurs due to low thermal conductivity of the base plate. The insufficient heat diffusion may cause difficulty in energizing examination.

### SUMMARY OF THE INVENTION

An aspect of the present invention provides a sample stage for use in optical inspection comprising first to fourth plates each having a first side surface and a second side surface, the first side surface and the second side surface being adjacent and extending perpendicularly to each other, wherein the second side surface of the second plate is in contact with the first side surface of the first plate, the second side surface of the third plate is in contact with the first side surface of the second plate, the second side surface of the fourth plate is in contact with the first side surface of the third plate, and the second side surface of the first plate is in contact with the first side surface of the fourth plate, and wherein a first rectangular opening is formed by the first side surfaces of the first to fourth plates.

An aspect of the present invention provides a sample stage for use in optical inspection comprising a first and second L-shaped plates, each of the first and second L-shaped plates having first, second and third side surfaces, the first and second side surfaces being parallel and not facing each other, one end of the first side surface being adjacent to one end of the third side surface, one end of the second side surface being adjacent to the other end of the third side surface, wherein the second side surface of the second plate is in contact with the first side surface of the first plate, and the second side surface of the first plate is in contact with the first side surface of the second plate, and wherein a first rectangular opening is formed by the first side surfaces and third side surfaces of the first and second plates.

### BRIEF DESCRIPTION OF THE DRAWINGS

FIG. 1A is a plan view showing a sample stage according to a first embodiment of the invention

FIG. 1B is a cross-sectional view of the sample stage taken along line A-A of FIG. 1A when viewed from an arrow direction.

FIG. 1C is a cross-sectional view of the sample stage taken along line B-B of FIG. 1A when viewed from an arrow direction.

FIG. 2 is a perspective view showing a main portion of the sample stage according to the first embodiment.

FIG. 3 is a plan view to explain a method of assembling the sample stage according to the first embodiment.

FIG. 4A is a diagram showing a state where a semiconductor chip is placed on the sample stage according to the first embodiment.

FIG. 4B is a diagram showing a state where a semiconductor chip is placed on a sample stage in a comparative example.

FIG. 5 is a plan view showing the sample stage according to the first embodiment in a state where a size of an opening is varied.

FIG. 6 is a plan view showing a modification of the sample stage according to the first embodiment.

FIG. 7 is a perspective view showing a main portion of the modification of FIG. 6.

FIG. 8 is a cross-sectional view showing the main portion of the modification of FIG. 6.

FIG. 9A is a plan view showing a sample stage according to a second embodiment of the invention.

FIG. 9B is a cross-sectional view of the sample stage taken along line C-C of FIG. 9A when viewed from an arrow direction.

FIG. 9C is a cross-sectional view of the sample stage taken along line D-D of FIG. 9A when viewed from an arrow direction.

FIG. 10 is a perspective view showing a main portion of the sample stage according to the second embodiment.

FIG. 11 is a plan view showing the sample stage according to the second embodiment in a state where a size of an opening is varied.

FIG. 12A is a plan view showing a sample stage according to a third embodiment of the invention.

FIG. 12B is a cross-sectional view of the sample stage taken along line E-E of FIG. 12A when viewed from an arrow direction.

FIG. 12C is a cross-sectional view of the sample stage taken along line F-F of FIG. 12A when viewed from an arrow direction.

FIG. 13 is a perspective view showing a main portion of the sample stage according to the third embodiment.

FIG. 14 is a diagram showing a state where a semiconductor chip is placed on the sample stage according to the third embodiment.

FIG. 15 is a plan view showing a sample stage according to a fourth embodiment of the invention.

### DETAILED DESCRIPTION OF THE INVENTION

Embodiments of the invention will be hereinafter described with reference to the drawings.

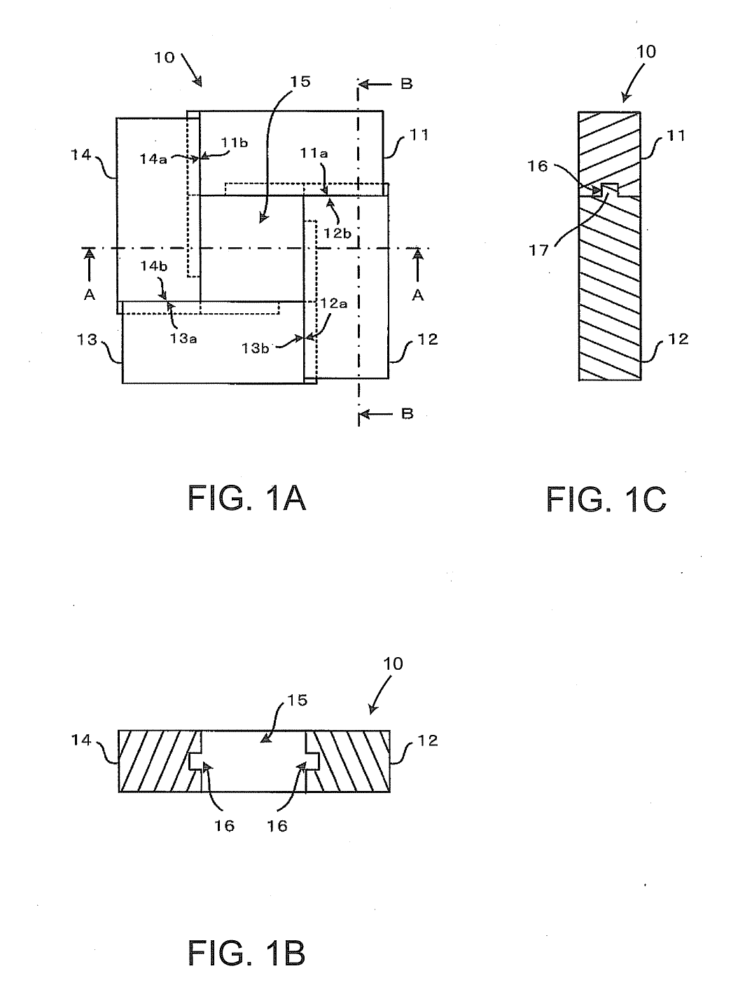

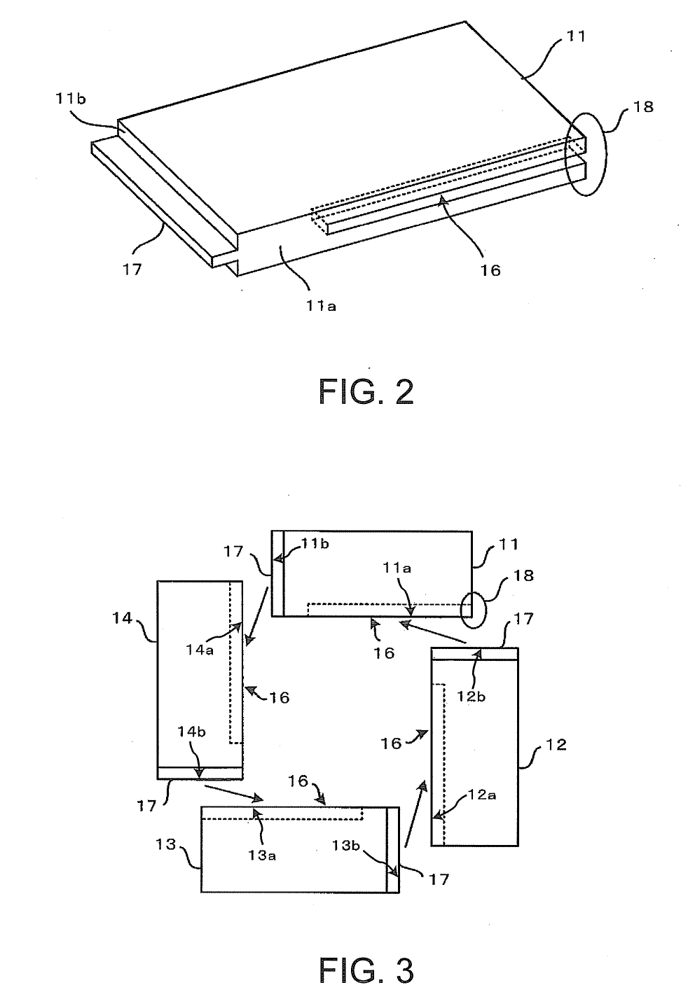

A sample stage according to a first embodiment of the invention will be described with reference to FIGS. 1A through 1C and FIG. 2.

FIG. 1A is a plan view showing the sample stage according to the first embodiment. FIG. 1B is a cross-sectional view of the sample stage taken along line A-A of FIG. 1A when viewed from an arrow direction. FIG. 1C is a cross-sectional view of the sample stage taken along line B-B of FIG. 1A when viewed from an arrow direction. FIG. 2 is a perspective view showing a main portion of the sample stage according to the first embodiment.

As shown in FIGS. 1A through 1C, a sample stage 10 of the embodiment includes first to fourth rectangular (multi-sided) plates 11 to 14. The first to fourth plates 11 to 14 respectively have the first side surfaces 11a to 14a and the second side surfaces 11b to 14b. The first side surfaces 11a are adjacent to the second side surfaces 11b to 14b at their end portions. The second side surfaces 11b extend perpendicularly to the first side surfaces 11a to 14a.

The second side surface 12b of the second plate 12 is in contact with the first side surface 11a of the first plate 11. The second side surface 13b of the third plate 13 is in contact with the first side surface 12a of the second plate 12. The second side surface 14b of the fourth plate 14 is in contact with the first side surface 13a of the third plate 13. The second side surface 11b of the first plate 11 is in contact with the first side surface 14a of the fourth plate 14.

A rectangular opening 15 is formed by the first side surfaces ha to 14a, which are in contact with the second side surfaces 11b to 14b. The size of the opening 15 can be changed by sliding the contact positions between the first side surfaces 11a to 14a and the second side surfaces 11b to 14b.

As shown in FIGS. 1B, 1C and 2, a guide groove 16 is formed on the first side surface 11a of the first plate 11. The guide groove 16 is open at an end 18 opposite to the second side surface 11b. A convex portion 17 to be fitted with the guide groove 16 is formed on the second side surface 11b of the first plate 11.

The cross-sections of the guide groove 16 and the convex portion 17 are rectangular, for example. A similar guide grooves and convex portions are formed in the second to fourth plates 12 to 14, respectively.

The first to fourth plates 11 to 14 are made of a metal plate with good thermal conductivity, such as a copper plate, for example. The metal plate is about 3 mm thick, for example. In order to manufacture such a metal plate, a guide groove having a width of about 1 mm and a convex portion having a width of 0.9 mm are formed in the copper plate by grinding processing, for example. Subsequently, nickel-chrome (NiCr) is electrolytically plated to form a nickel-chrome film of an about 10 μm thickness, for example, on the copper plate, in order to complete each of the first and fourth plates 11 to 14.

As shown in FIG. 3, in order to manufacture the sample stage of FIG. 1A, the convex portion 17 of the second plate 12 is disposed to oppose to the guide groove 16 of the first plate 11. The convex portion 17 of the second plate 12 is pressed into and is fit into the guide groove 16. This fitting brings the first side surface 11a of the first plate 11 into contact with the second side surface 12b of the second plate 12. The convex portion 17 of the third plate 13 is disposed to oppose to the guide groove 16 of the second plate 12. The convex portion 17 of the third plate 13 is pressed into and fit into the guide groove 16. This fitting allows the first side surface 12a of the second plate 12 to be in contact with the second side surface 13b of the third plate 13.

The convex portion 17 of the fourth plate 14 is disposed to oppose to the guide groove 16 of the third plate 13. The convex portion 17 of the fourth plate 14 is pressed into and fit into the guide groove 16. This fit allows the first side surface 13a of the third plate 13 to be in contact with the second side surface 14b of the fourth plate 14.

The convex portion 17 of the first plate 11 is disposed to oppose to the guide groove 16 of the fourth plate 14. The convex portion 17 of the first plate 11 is pressed into and fit into the guide groove 16. This fit allows the first side surface 14a of the fourth plate 14 to be in contact with the second side surface 11b of the first plate 11.

A predetermined opening size is obtained for the opening 15 by sliding the convex portions 17 relative to and along the respective guide grooves 16, while keeping the first to fourth plates 11 to 14 in contact with one another, as described above.

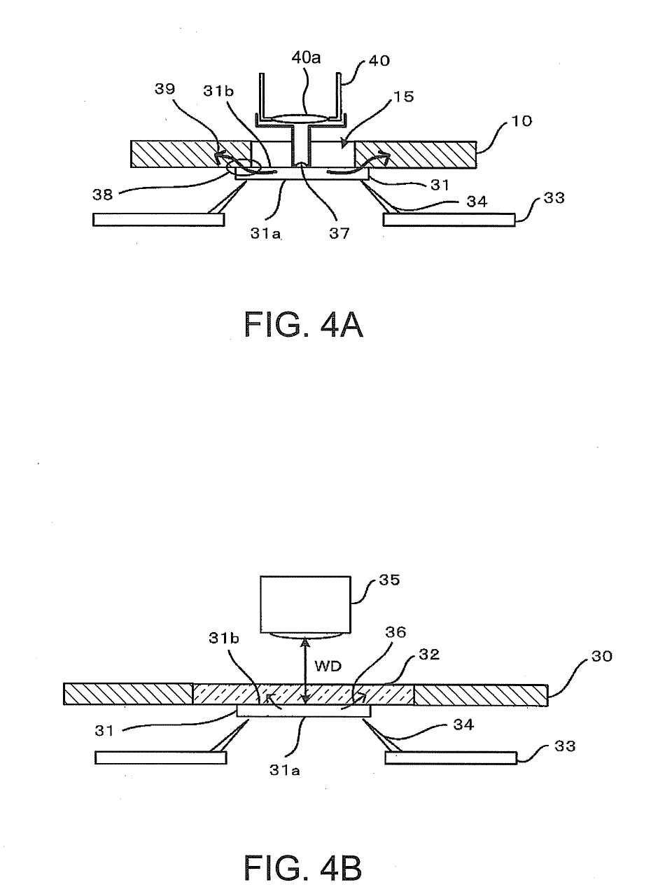

FIG. 4A shows the sample stage 10 of the embodiment in a state that a semiconductor chip is placed on the sample stage 10. FIG. 4B is a diagram showing a comparative example of a sample stage in a state that a semiconductor chip is placed on a sample stage, in order to make comparison with the embodiment.

In FIG. 4B, the comparative example is a sample stage 30 which does not have an opening as the opening 15. The sample stage 30 is provided with a base plate such as a glass plate 32, which is transparent to infrared light. The base plate is disposed in a position corresponding to the opening 15. The structure of the sample stage 30 and a method of using the sample stage 30 will be described in detail. The sample stage 30 does not have a portion corresponding to the opening 15 of the first embodiment shown in FIG. 1A.

The glass plate 32 has a size larger than that of a semiconductor chip 31. The glass plate 32 is provided in the center of the sample stage 30 of the comparative example. The glass plate 32 is provided in a position corresponding to the opening 15 of the FIG. 1A. The semiconductor chip 31 is attached on the glass plate 32. In order to perform attaching the semiconductor chip 31, a space between the semiconductor chip 31 and the sample stage 30 is filled with an underfill (not shown). The underfill allows the semiconductor chip 31 to tightly adhere to the glass plate 32. The sample stage 30 is fixed-to face downward by a sample stage chuck (not shown).

The semiconductor chip 31 is placed on the sample stage 30 so that probing can be carried out from an electrode side surface (a first surface) 31a of the semiconductor chip 31 to an electrode pad (not shown) formed on the electrode side surface 31a, in order to energize the internal circuit of the semiconductor chip 31. The light from the inside of the semiconductor chip 31, which is generated by energizing the semiconductor chip 31, can be detected by an objective lens 35 through the glass plate 32 from the back surface (a second surface) side 31b of the semiconductor chip 31.

The probing into the electrode pad is carried out by a probe 34 attached to a probe card 33.

The glass plate 32 has a thermal conductivity lower than that of metal. It is therefore difficult to diffuse the heat of the glass plate 32 when the semiconductor chip 31 generates a large amount of heat by the energizing.

When heat diffusion 36 is insufficient, an operating condition of the semiconductor chip 31, which is capable of suppressing occurrence of heat, have to be selected, even if the condition is not desirable. Thus, a failure of the semiconductor chip 31 can not be reproduced under desired conditions, which make it difficult to analyze the failure.

The glass plate 32 needs to have a thickness enough to withstand a probing load. A working distance WD, which is a distance between the back surface 31b of the semiconductor chip 31 and the objective lens 35, may be limited.

Accordingly, it is difficult to use the objective lens 35 having a large numerical aperture (NA). Resolution of an optical image, which is obtained through the objective lens 35, is reduced. Light collection efficiency is also reduced as well. As a result, the image quality of detected image is reduced, resulting in possible reduction in sensitivity and accuracy of failure analysis.

On the other hand, the sample stage 10 of the embodiment, which is shown in FIG. 1A, is made of copper having good thermal conductivity. As shown in FIG. 4A, the opening 15 of the sample stage 10 has a size smaller than that of the semiconductor chip 31. The opening 15 of the sample stage 10 has a size larger than an area to detect the light from the internal circuit.

The semiconductor chip 31 is placed such as to cross the opening 15 of the sample stage 10, while partly overlapping the under surface of the sample stage 10. Carbon wax is applied around the semiconductor chip 31 to bond the semiconductor chip 31 and the sample stage 10. The semiconductor chip 31 is attached to the sample stage 10 by the carbon wax.

In FIG. 4A, the internal circuit of the semiconductor chip 31 is energized by carrying out probing from the electrode side surface (first surface) 31a of the semiconductor chip 31 to an electrode pad (not shown), which is formed on the electrode side surface 31a. From the side of the back surface 31b (second surface) of the semiconductor chip 31, an optical component 37 of a microscope 40 may come close to or is firmly attached to the back surface 31b of the semiconductor chip 31.

The light from the inside of the semiconductor chip 31, which is generated when the semiconductor chip 31 is energized, is caused to enter a lens 40a of the microscope 40 through the optical component 37, and then detected.

The sample stage 10 of copper has higher thermal conductivity as compared to the glass plate 32 of FIG. 4B. Accordingly, the heat, which is generated by energizing the semiconductor chip, can easily be diffused through overlapping portions 38 formed between the semiconductor chip 31 and the sample stage 10. In the embodiment, heat diffusion 39 is sufficiently performed. Failure may be reproduced without any problem. Consequently, sufficient failure analysis can be performed.

The optical component 37 such as a silicon-made dome lens called as “Solid Immersion Lens (SIL)” may be tightly attached to the back surface 31b of the semiconductor chip 31 through the opening 15 of the sample stage 10. High refraction index oil can be used to tightly attach the optical component 37 to the semiconductor chip 31.

According to the embodiment, a glass plate as the glass plate 32 used in the comparative example of FIG. 4B is not used. Total reflection of light at the back surface 31b of the semiconductor chip 31 can be suppressed by causing the optical component 37 to be close to or tightly attached to the semiconductor chip 31. Accordingly, light extraction efficiency is improved. Sufficient light collection efficiency and high resolution can be obtained.

According to the embodiment, the electrode pad on the electrode side surface 31a of the semiconductor chip 31 can be formed in the overlapping portion 38. Accordingly, the probing load can be sufficiently supported by the sample stage 10.

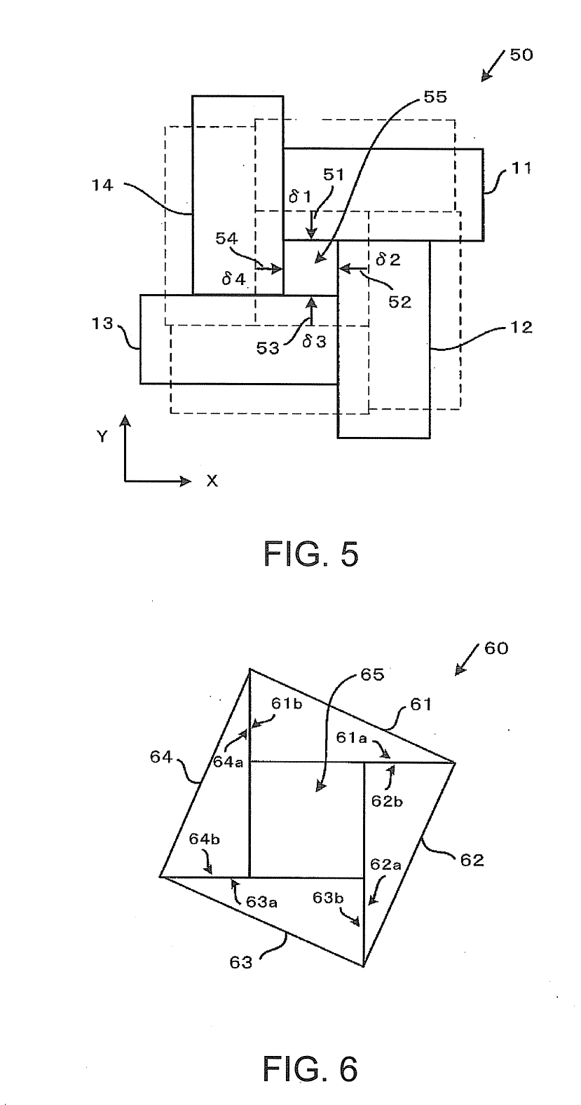

FIG. 5 is a diagram showing a method of varying the size of the opening by sliding the first to fourth plates 11 to 14 relative to each other.

As shown in FIG. 5, for example, the first plate 11 is slid for a distance of δ1 in −Y direction shown by an arrow 51, and the second plate 12 is slid for a distance of δ2 in −X direction shown by an arrow 52. The third plate 13 is slid for a distance of δ3 in +Y direction shown by an arrow 53, and the fourth plate 14 is slid for a distance of δ4 in +X direction shown by an arrow 54.

By the above method, a sample stage 50 is obtained, which has a rectangular opening 55 of a size smaller than that of the opening 15 of the sample stage 10 of FIG. 1A.

The sliding distances δ1 to δ4 may be voluntary, as long as the first to fourth plates 11 to 14 can be in contact with each other. The sliding distances δ1 to δ4 may be equal to or different from each other.

If the sliding distances δ1 to δ4 are equal to each other, the opening 55 may have a shape similar to that of the opening 15 of FIG. 1A. If sliding directions are inverted, an opening may have a size larger than that of the opening 15 of FIG. 1A.

The first to fourth plates 11 to 14 described in the embodiment are rectangular, while other polygon-shaped plates may be used.

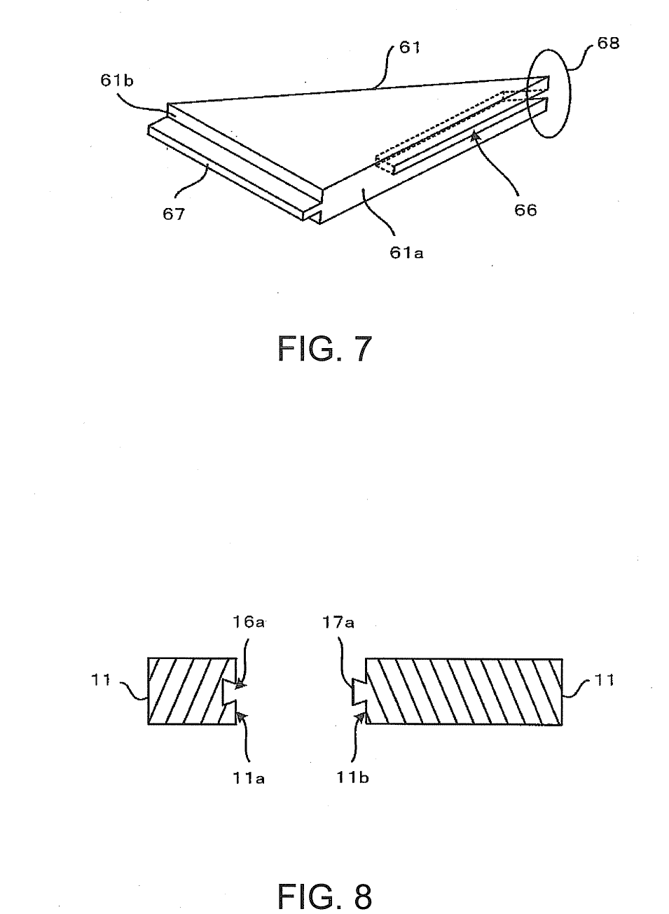

FIG. 6 is a plan view showing a sample stage having the polygon-shaped plates as a modification of the embodiment. FIG. 7 is a perspective view showing a main portion of the sample stage according to the modification.

As shown in FIG. 6, a sample stage 60 includes first to fourth right-triangular plates 61 to 64. The first to fourth plates 61 to 64 have first side surfaces 61a to 64a and second side surfaces 61b to 64b respectively. The first side surfaces 61a to 64a and the second side surfaces 61b to 64b are adjacent to each other respectively. The first side surfaces 61a to 64a are perpendicular to the second side surfaces 61b to 64b respectively.

As shown in FIG. 7, the first plate 61 has the first side surface 61a and the second side surface 61b is adjacent to and perpendicular to each other. A guide groove 66 open at an end 68 is formed on the first side surface 61a. A convex portion 67 to be fitted into the guide groove 66 is formed on the second side surface 61b. The cross-sections of the guide groove 66 and the convex portion 67 are rectangular, for example. The second to fourth plates 62 to 64 have the same structure.

Such structures of the first to fourth plates 61 to 64 allow for the formation of an opening 65 having the same size as that of the opening 15 of FIG. 1A, as shown in FIG. 6. The sample stage 60 of FIG. 6 has an advantage of having a size smaller than that of the sample stage 10 of FIG. 1A.

In the above first embodiment, the guide groove 16 and the convex portion 17 are rectangular. The guide groove 16 and the convex portion 17 only need to have a shape which fit with each other, and are not particularly limited to a rectangular shape.

As shown in FIG. 8, the first plate 11 may have a guide groove 16a having a cross-section of a shape widened inward from the first side surface 11a Further, the first plate 11 may have a convex portion 17a having a cross-section of a shape widened outward from the second side surface 11b. The other second to fourth plate 11 to 14 may have the same structure. In FIG. 8, the width of the guide groove 16a is gradually increased from the open end toward the groove bottom. The width of the convex portion 17a is gradually increased from the bottom toward the leading edge.

When plates having a shape of the cross-section shown in FIG. 8 is used for a sample stage and when guide grooves and convex portions as the guide groove 16a and the convex portion 17a are formed in the plates respectively to fit with each other, the guide grooves and the convex portions are engaged with each other so as to be hardly disengaged, resulting in the unification of the sample stage.

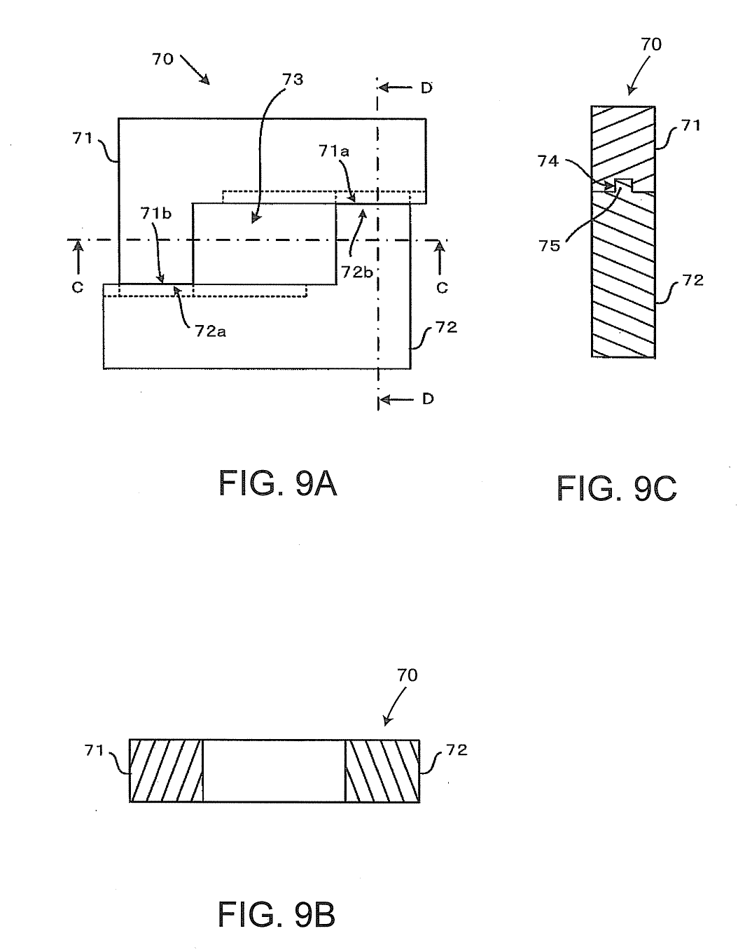

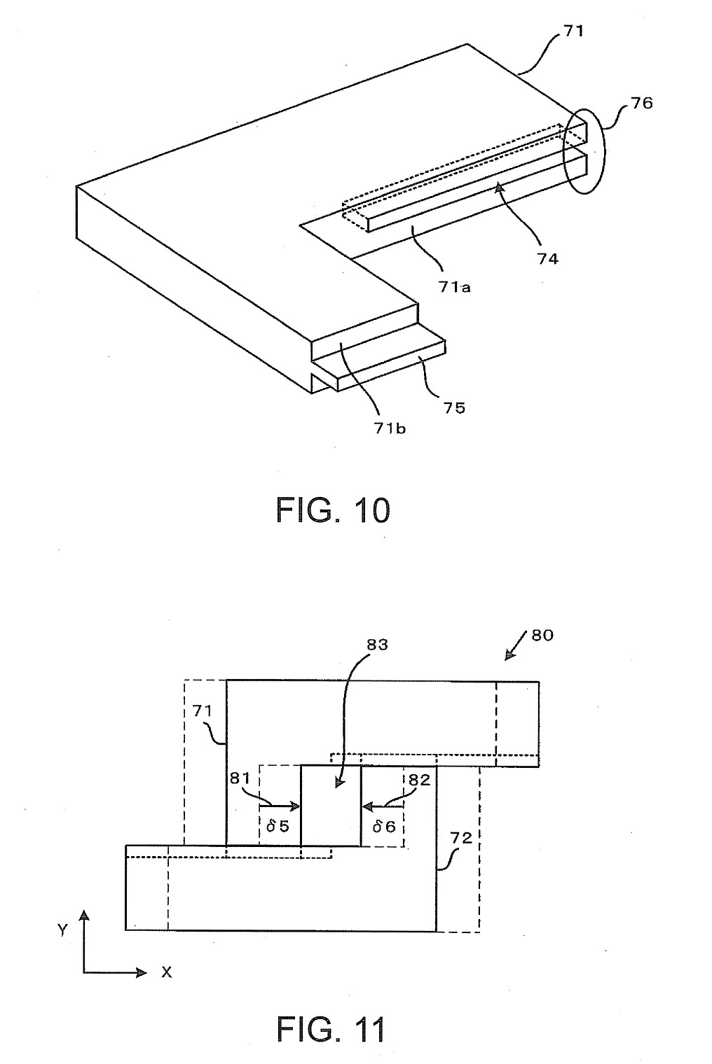

A sample stage according to a second embodiment of the invention will be described with reference to FIGS. 9A to 9C and 10. FIG. 9A is a plan view showing the sample stage according to the second embodiment of the invention. FIG. 9B is a cross-sectional view of the sample stage taken along line C-C of FIG. 9A when viewed from an arrow direction. FIG. 9C is a cross-sectional view of the sample stage taken along line D-D of FIG. 9A when viewed from an arrow direction. FIG. 10 is a perspective view showing a main portion of the sample stage according to the second embodiment.

In the embodiment, the same reference numerals as those used in the first embodiment denote the same portions respectively.

As shown in FIGS. 9A to 9C, the sample stage 70 of the embodiment includes the L-shaped first and second plates 71 and 72.

The first plate 71 has a first side surface 71a and a second side surface 71b. The first plate 71 has a first side surface 71a and a second side surface 71b are parallel to each other and do not face each other. The second plate 72 has a first side surface 72a and a second side surface 72b. The first side surface 72a and a second side surface 72b are parallel to each other and do not face each other.

The second side surface 72b of the second plate 72 is caused to come into contact with the first side surface 71a of the first plate 71. The second side surface 71b of the first plate 71 is caused to come into contact with the first side surface 72a of the second plate 72. The contacting allows for formation of a rectangular opening 73.

The contact position between the first side surface 71a and the second side surface 72b and the contact position between the first side surface 72a and the second side surface 71b can be slid in a sliding direction (a direction parallel to the first side surface) to vary the size of the opening 73.

As shown in FIG. 10, a guide groove 74 and a convex portion 75 are formed in the first plate 71. The guide groove 74 is formed on the first side surface 71a. In the guide groove 74, an end 76 provided at the side opposite to the second side surface 71b is open. The convex portion 75 is formed on the second side surface 71b. The convex portion 75 is fitted into the guide groove 74.

The guide groove 74 and the convex portion 75 are, for example, rectangular in cross-section. Similarly, a guide groove and a convex portion having the same shape are formed in the second plate 72.

FIG. 11 shows a method of varying the size of the opening by sliding the first and second plates 71 and 72 relative to each other.

As shown in FIG. 11, for example, the first plate 71 is slid for a distance of δ5 in a +X direction shown by an arrow 81. The second plate 72 is slid for a distance of 66 in a −X direction shown by an arrow 82. The size of a rectangular opening 83 of a sample stage 80 is reduced in a sliding direction as compared to the opening 73 of the sample stage 70, which is shown in FIG. 9A.

The sliding distances δ5 and δ6 may be voluntary as long as the first and second plates 71 and 72 are in contact with each other. The sliding distances δ5 and δ6 may be equal to or different from each other.

An opening, which has a size larger in the sliding direction than that of the opening 73 of the sample stage 70, is obtained by inverting the sliding direction shown in FIG. 11.

The embodiment is suitable to place a semiconductor chip such as a memory chip, which has bonding pads on only two opposite sides. Probing can be carried out to an electrode pad formed on the electrode side surface of the semiconductor chip so as to energize an internal circuit of the semiconductor chip.

The optical component 37 can be close to or firmly attached to a back surface opposite to the electrode side surface of the semiconductor chip to detect the light from the internal circuit.

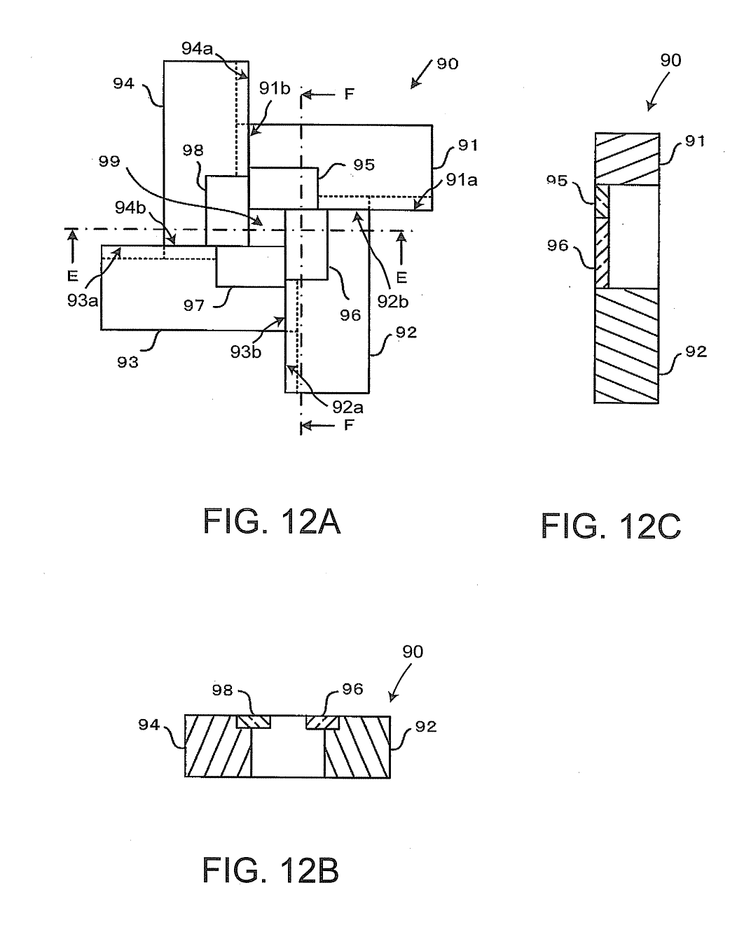

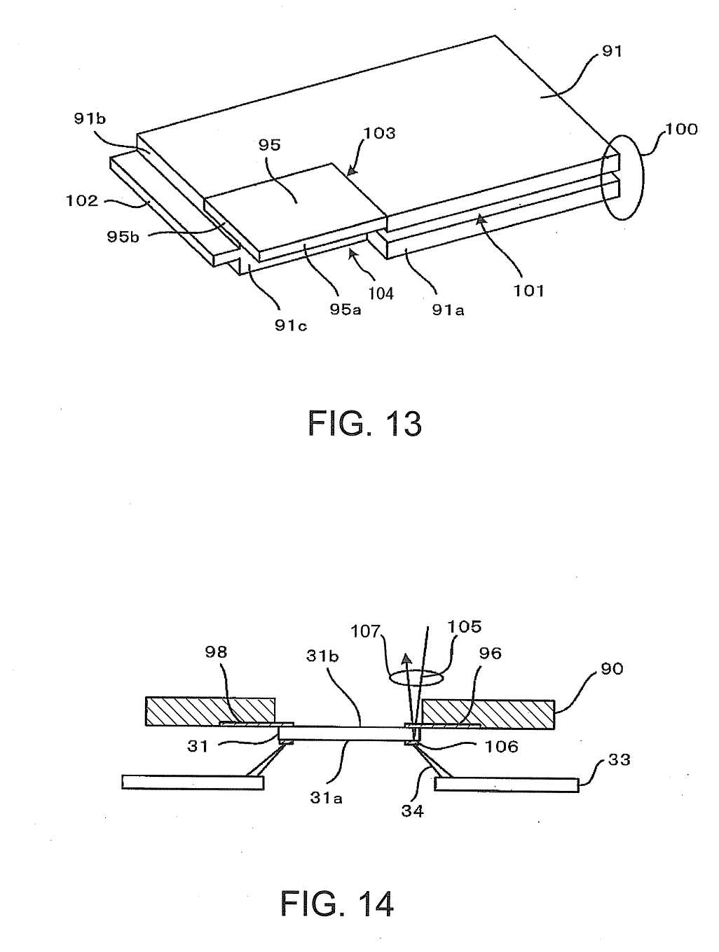

A sample stage according to a third embodiment of the invention will be described with reference to FIGS. 12A to 12C and 13. FIG. 12A is a plan view showing the sample stage according to the third embodiment of the invention. FIG. 12B is a cross-sectional view of the sample stage taken along line E-E of FIG. 12A when viewed from an arrow direction. FIG. 12C is a cross-sectional view of the sample stage taken along line F-F of FIG. 12A when viewed from an arrow direction. FIG. 13 is a perspective view showing a main portion of the sample stage according to the third embodiment.

In FIGS. 12A to 12C and 13, the same reference numerals as those shown in FIGS. 1A to 1C and 2 denote the same portions respectively.

As shown in FIGS. 12A to 12C, the first to fourth plates 91 to 94 of the sample stage 90 of the embodiment have the first side surfaces 91a to 94a and the second side surfaces 91b to 94b respectively. The first side surfaces 91a to 94a and the second side surfaces 91b to 94b are adjacent to and perpendicular to each other respectively.

Transparent members 95 to 98, which are transparent to infrared light respectively, are fitted within corner positions formed by the first side surfaces 91a to 94a and the second side surfaces 91b to 94b.

The first side surfaces 91a to 94a and the second side surfaces 91b to 94b are alternately in contact with each other in order to form an opening 99 surrounded by the transparent members 95 to 98.

If a semiconductor chip is placed on the sample stage 90, the outer circumference of the semiconductor chip 31 overlaps the transparent members 95 to 98. Accordingly, alignment between a pad on an electrode side surface of the semiconductor chip can be carried out from a back surface side of the semiconductor chip 31. Probing can be carried out from the back surface side of the semiconductor chip 31 as well.

As shown in FIG. 13, the first side surface 91a and second side surface 91b of the first plate 91 are perpendicular to and adjacent to each other. A guide groove 101, which is provided on the first side surface 91a, and a convex portion 102, which is provided on the second side surface 91b, are formed in the first plate 91. In the guide groove 101, an end 100 opposite to the second side surface 91b is open. The convex portion 102 is fitted into the guide groove 101. The cross-sections of the guide groove 101 and the convex portion 102 are rectangular, for example.

The transparent member 95 is a rectangular glass plate transparent to infrared light. The transparent member 95 is about 1 mm thick. The transparent member 95 has a first side surface 95a and a second side surface 95b, which are adjacent to and perpendicular to the first side surface 95a.

A corner portion 104 of the first plate 91, which is constructed of the first side surface 91a and the second side surface 91b, is cut out from the first side surface 91a. A side surface 91C parallel to the first side surface 91a is formed at the cut out corner portion 104 to construct a step structure. A thin rectangular concave 103 is provided in a direction perpendicular to the side surface 91c of the first plate 91. The concave 103 is formed so as to have a depth not extending to the convex portion 102.

The transparent member 95, which has a thin rectangular solid shape, is fitted into the concave 103. The transparent member 95 is fixed to the concave 103 with an adhesive. The first side surface 95a and second side surface 95b of the transparent member 95 are adjacent to and perpendicular to each other.

The first side surface 95a of the transparent member 95 and the first side surface 91a of the first plate 91 form approximately the same plane. The second side surface 95b of the transparent member 95 and the second side surface 91b of the first plate 91 form approximately the same plane. The transparent member 95 projects from the side surface 91c of the first plate 91 in a direction of the second side surface 95b.

The second to fourth plates 92 to 94 have the same structure as that of the first plate 91.

FIG. 14 is a diagram showing the sample stage 90 in a state that a semiconductor chip is placed on the sample stage 90. In FIG. 14, the same reference numerals as those shown in FIG. 4A denote the same portions. As shown in FIG. 14, the semiconductor chip 31 is placed so as to overlap the transparent members 95 to 98 of the sample stage 90 partly.

A space between the semiconductor chip 31 and the transparent members 95 to 98 is filled with an underfill (not shown), which is transparent to infrared light. The semiconductor chip 31 is firmly attached via the underfill to the transparent members 95 to 98. In FIG. 14, the sample stage 90 is fixed by means of a sample stage chuck so that the sample stage 90 shown in FIG. 12A faces downward.

Infrared light 105 enters from the side of the back surface 31b of the semiconductor chip 31 through the objective lens 107 of an infrared microscope.

The infrared light penetrates the transparent member 96 and the semiconductor chip 31, is reflected by a pad 106 formed on an electrode side surface 31a of the semiconductor chip 31, and returns to the infrared microscope.

By using the infrared microscope, alignment between the probe 34 and the electrode pad 106, which is formed on the electrode side surface 31a of the semiconductor chip 31, can be carried out from the side of the back surface 31b of the semiconductor chip 31.

The embodiment may allow using a simpler optical system, as compared to an optical system where alignment is carried out between the probe 34 and the electrode pad 106 from the side of the electrode side surface 31a by using a mirror reflector and a visible light microscope, for example.

In the embodiment, glass is used as the transparent members 95 to 98. The thermal conductivity of glass such as silica glass (up to 1.6 W/mK) is lower than that of copper (up to 400 W/mK). Accordingly, the transparent members 95 to 98 deteriorate heat diffusion from the semiconductor chip 31. In order to increase heat diffusion, it is desirable to minimize the size of the transparent members 95 to 98.

Furthermore, it is desirable to use a material having thermal conductivity higher than that of silica glass for the transparent members 95 to 98. The material may sapphire (up to 37 W/mK), MgO (up to 55 W/mK) or SiC (up to 350 W/mK). Diamond (up to 2000 W/mK) is most suitable.

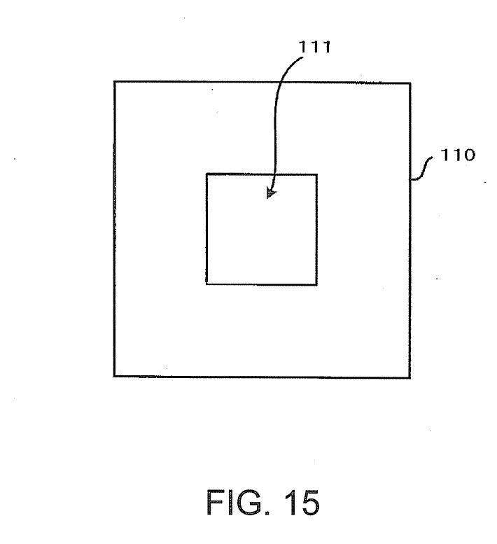

The same transparent members may be provided on the sample stage 60 of FIG. 6, on the sample stage 70 of FIG. 9 or on the sample stage 110 of FIG. 15, as will be described below.

In the foregoing embodiments, each sample stage is constructed of a plurality of plates. The plates are alternately in contact with each other to form rectangular opening. The size of the opening is varied by sliding the contact position. A single plate with a predetermined opening formed may be used in place of a plurality of such plates.

FIG. 15 is a plan view showing a sample stage according to a fourth embodiment of the invention. As shown in FIG. 15, the sample stage 110 is constructed of a single plate. An opening 111 is formed in the center of the sample stage 110. The size of the opening 111 is smaller than that of the semiconductor chip 31 described above. The size of the opening 111 is larger than an area of the semiconductor chip 31 for detecting light generated from the inside of the semiconductor chip 31.

In this case, multiple kinds of the sample stage 110 may be prepared. The multiple kinds of the sample stage 110 may be used to detect light from the semiconductor chip 31. The use of the multiple kinds of the sample stage 110 may be effective, when the size of the semiconductor 31 to be observed is limited to several sizes.

Other embodiments or modifications of the present invention will be apparent to those skilled in the art from consideration of the specification and practice of the invention disclosed herein. It is intended that the specification and example embodiments to be considered as exemplary only, with a true scope and spirit of the invention being indicated by the following.

What is claimed is:

1. A sample stage for use in optical inspection, comprising:
first to fourth plates each having a first side surface and a second side surface, the first side surface and the second side surface being adjacent and extending perpendicularly to each other, wherein
the second side surface of the second plate is in contact with the first side surface of the first plate,
the second side surface of the third plate is in contact with the first side surface of the second plate,
the second side surface of the fourth plate is in contact with the first side surface of the third plate, and
the second side surface of the first plate is in contact with the first side surface of the fourth plate, and wherein
a first rectangular opening is formed by the first side surfaces of the first to fourth plates.

2. The sample stage according to claim 1, wherein
each of the first side surfaces of the first to fourth plates is provided with a guide groove extending along the first side surface,
each of the second side surfaces of the first to fourth plates is provided with a convex portion extending along the second side surface, and
the convex portions are fitted into the guide grooves.

3. The sample stage according to claim 1, further comprising four transparent members attached to the first to fourth plates, respectively, wherein
the four transparent members form a second opening.

4. The sample stage according to claim 3, wherein the first opening has approximately the same shape as that of the second opening.

5. The sample stage according to claim 3, wherein
corner portions are formed by the first side surfaces and the second side surfaces of the first to fourth plates respectively,
portions of the corner portions adjacent to at least the second opening are cut out at the corner portions respectively, and
the transparent members are disposed at the cut-out portions respectively.

6. The sample stage according to claim 5, wherein
concave portions are formed at the corners, respectively, and
the transparent members are attached to the concave portions, respectively.

7. The sample stage according to claim 5, wherein the thermal conductivity of the first to fourth plates is larger than that of the transparent members.

8. The sample stage according to claim 2, wherein the first to fourth plates are rectangular.

9. The sample stage according to claim 1, wherein each of the first side surfaces is slidable relative to a corresponding one of the second side surfaces.

10. The sample stage according to claim 2, wherein the first to fourth plates are right-triangular.

11. The sample stage according to claim 3, wherein the transparent members are rectangular.

12. The sample stage according to claim 2, wherein
a bottom portion width of each of the guide grooves is larger than an open end portion width of the guide groove, and
a projecting end portion width of each of the convex portions is larger than a root portion width of the convex portion.

13. The sample stage according to claim 12, wherein
the width of each of the guide grooves is gradually increased from the open end portion to the bottom portion, and
the width of each of the convex portions is gradually increased from the root portion to the protruding end portion.

14. A sample stage for use in optical inspection, comprising
a first and second L-shaped plates, each of the first and second L-shaped plates having first, second and third side surfaces, the first and second side surfaces being parallel and not facing each other, one end of the first side surface being adjacent to one end of the third side surface, one end of the second side surface being adjacent to the other end of the third side surface, wherein
the second side surface of the second plate is in contact with the first side surface of the first plate, and
the second side surface of the first plate is in contact with the first side surface of the second plate, and wherein
a first rectangular opening is formed by the first side surfaces and third side surfaces of the first and second plates.

15. The sample stage according to claim 14, wherein,
each of the first side surfaces of the first and second plates is provided with a guide groove extending along the first side surface,
each of the second side surface of the first and second plates is provided with a convex portion extending along the second side surface, and
the convex portions are fitted into the guide grooves.

16. The sample stage according to claim 14, further comprising two transparent members attached to the first and second plates, respectively, wherein
the transparent members form a second opening.

17. The sample stage according to claim 16, wherein the thermal conductivity of the first and second plates is larger than that of the transparent members.

18. The sample stage according to claim 15, wherein
a bottom portion width of each of the guide grooves is larger than an open end portion width of the guide groove, and
a projecting end portion width of each of the convex portions is larger than a root portion width of the convex portion.

19. The sample stage according to claim 18, wherein
the width of each of the guide grooves is gradually increased from the open end portion to the bottom portion, and
the width of each of the convex portions is gradually increased from the root portion to the protruding end portion.

20. The sample stage according to claim 14, wherein each of the first side surfaces is slidable relative to a corresponding one of the second side surfaces.
